(19) United States
(12) Patent Application Publication
(10) Pub. No.: US 2011/0155657 A1
(43) Pub. Date: Jun. 30, 2011

(54) TEE-CONNECTOR FOR USE IN A FILTRATION SYSTEM

(75) Inventors: Gregory Collins, Monroe, NY (US); James Summerton, Park Ridge, NJ (US)

(73) Assignee: Nephros, Inc., River Edge, NJ (US)

(21) Appl. No.: 12/978,565

(22) Filed: Dec. 26, 2010

Related U.S. Application Data
(60) Provisional application No. 61/290,915, filed on Dec. 30, 2009.

(51) Int. Cl. B01D 35/30

(52) U.S. Cl. 210/232

(57) ABSTRACT

In accordance with one embodiment, a connector for use in a fluid circuit includes a first housing having a hollow interior and an inlet and an outlet. The hollow interior includes first filter elements that are open at first and second ends thereof. The first ends of the first filter elements are in fluid communication with the inlet, while the second ends are in fluid communication with the outlet. The connector also includes a second housing that is in fluid communication with the hollow interior of the first housing. The second housing contains second filter elements that are arranged in a U-shape and are open at first and second ends thereof that are disposed proximate an outlet of the second housing. Fluid is conducted across the first filter elements to gain access to the second housing where the fluid is conducted across the second filter elements in order to exit to the second housing through the outlet.

### CROSS-REFERENCE TO RELATED APPLICATION

The present application claims the benefit of U.S. patent application Ser. No. 61/290,915, filed Dec. 30, 2009, which is hereby incorporated by reference in its entirety.

### TECHNICAL FIELD

The present invention relates to a method and system for filtering and purifying a fluid, such as water, and in particular, the present invention relates to using a hybrid tee-connector that can be used in a water circuit to filter and purify water that is then made available to an external device, such as a dialysis machine, which requires purified water to ensure patient safety.

### BACKGROUND

The tap water that we consume every day goes through a number of water treatment stages before it is ready to be consumed or used for daily purpose. Water is generally directed through several stages of treatment, such a carbon bed treatment stage and a multimedia filtration stage, to ensure the removal of all unwanted materials. The first filtration stage removes the most concentrated chemicals, like chlorine, while subsequent stages remove smaller and more evasive chemicals, like pesticides.

Water is treated and filtered to allow for human consumption (potable drinking water) and in addition, water purification devices can be incorporated into other systems designed for a variety of other purposes, including to meet the requirements of medical, pharmacology, chemical and industrial applications. Water purification is the process of removing undesirable chemicals, materials, and biological contaminants from raw water. In general, the methods used for water purification include physical processes, such as filtration and sedimentation, biological processes, such as slow sand filters or activated sludge, chemical processes, such as flocculation and chlorination and the use of electromagnetic radiation, such as ultraviolet light. The goal is to produce bacterial free water fit for consumption and fit for other uses, such as institutional medical uses.

The standards for drinking water quality are typically set by governments or by international standards. These standards will typically set minimum and maximum concentrations of contaminants that are permissible in the water and depending upon the particular water application. Unfortunately, many times it is not possible to tell whether water is of an appropriate quality by visual examination alone.

Special precautions are to be taken when the water is to be used for medical purposes, especially for blood transfusion or dialysis. If the water contains an impurity or bacteria and is delivered to such a machine, then the patient's health and safety are at risk.

FIG. 1 shows a conventional water filtration system or circuit 100 of the type that can be used in a number of different settings including a setting where external devices are connected thereto for delivery of filtered water to these external devices.

Untreated water from a source (not shown) is introduced into the system 100 and is delivered to a first water treatment unit or stage 110 that is designed to treat the water and remove at least one contaminant. For example, the first water treatment stage 110 can be configured to remove chlorine from the water and in this case, the first water treatment unit 110 includes one or more carbon beds that are configured so that the water passes therethrough to ensure the removal of unwanted contaminants (e.g., chlorine). The carbon bed can be compressed into a solid block form or it can be present in more of a loose bed form.

The unit 110 can include other filter media in addition to the carbon bed and this type of water filter that includes several filter media is known as a multimedia filter. These filters clean water through both physical and chemical processes. Physically, they perform the same function as slow sand filters, blocking the passage of unwanted materials with molecular structures that are larger than water. Chemically, the carbon or multimedia filters perform an added filtration function. In a multimedia filter, one filtering stage can be designed to remove the most concentrated chemicals, like chlorine; while subsequent stages within the filter remove smaller and more evasive chemicals, like pesticides. Treated water (e.g., chlorine free water) from the first water treatment unit 110 is delivered to a first conduit section 115 that connects the first water treatment unit 110 to a second water treatment unit 120.

In the second water treatment unit 120, water is further treated. For example, the second water treatment unit 120 can be a water softening stage where “hardening” minerals like calcium and magnesium are removed from the water. In order to remove calcium and magnesium from water, water softeners chemically replace the calcium and magnesium ions with sodium ions. Treated water that exits the second treatment unit 120 flows through a second conduit section 125 which delivers the treated water downstream to another treatment stage. For example, the second conduit section 125 can connect the second treatment unit 120 to a reverse osmosis (RO) unit 130.

Reverse osmosis is the process of forcing a solvent from a region of high solute concentration through a semi-permeable membrane to a region of low solute concentration by applying pressure in excess of the osmotic pressure. The semi-permeable membrane used in reverse osmosis contains tiny pores through which water can flow. The small pores of this membrane are restrictive to such organic compounds as salt and other natural minerals, which generally have a larger molecular composition than water. These pores are also restrictive to bacteria and disease-causing pathogens. Thus, RO is very effective at desalinating water and providing mineral-free water for use in photo or print shops. It is also effective at providing pathogen-free water.

The RO unit 130 works by using pressure to force a solution through a membrane, retaining the solute on one side and allowing the pure solvent to pass to the other side. The filtered water from the RO unit 130 passes around through a main conduit section 135 that is configured to form an RO loop 140, such that unused water is circulated back to the RO unit. While, the RO unit 130 filters and purifies the water, there is a risk that bacteria can grow in the RO treated water especially since chlorine is not present in the water since it was previously eliminated at stage 110. This is especially the case when the RO treated water is permitted to stagnate. Based on the foregoing, RO circuits are designed to keep the RO treated water flowing at all times as by using pumps or the like to eliminate the chance or pooling and stagnation of the RO treated water.

RO circuits are typically employed in a setting where external devices are fluidly connected thereto to allow RO treated water to be delivered to the external devices where the water is used. In one embodiment, the RO circuit is used in a dialysis setting where the external devices are a plurality of dialysis machines 150a-150c. The machines 150a-150c are typically fluidly connected to the RO circuit by a plurality of conventional tee-connectors 145 are plumbed to the main conduit section 135. When water is required, water flows from the RO loop through the tee-connector 145 into the respective machine. It will be appreciated that when the water is not delivered directly into the machine (as when the machine is off line, etc.), the water remains in the tee-connector and unlike the water in the RO circuit, the water contained in the tee-connector 145 is not circulated and therefore, can form a stagnant pool. Consequently, the tee-connector 145 can foster the growth of bacteria and since the tee-connector 145 delivers water to the external device (dialysis device), the bacteria laden water will be delivered into the external device when water is permitted to flow thereto (e.g., as when a valve or the like is opened permitting water to flow from the tee-connector 145 to the external device).

FIG. 2 shows that water in the tee-connector 145 will not be able to circulate in the RO loop as it is in a small section of the tee-connector. As the water in the small section of the tee-connector is not circulating and is not a part of the RO loop, it will result in stagnant water 200 and therefore, a bio-film can grow. In addition to posing a serious risk for the connected external device when the external device is fluidly connected back to the RO circuit, the bacteria from the bio-film can break away and contaminate other parts of the RO loop 140. Due to this growth of bio-film, the entire RO loop can get contaminated and this can lead to a dangerous situation if bacteria is delivered to the dialysis machines 150a-150c.

There is therefore a need for a connector that can be used in water circuit to connect an external device to the water circuit and is of the type that overcomes the deficiencies of the conventional tee-connectors and in particular, eliminate the risk of bacteria being delivered to the external device.

### SUMMARY

In accordance with one embodiment, a connector for use in a fluid circuit includes a first housing having a hollow interior and an inlet and an outlet. The hollow interior includes first filter elements that are open at first and second ends thereof. The first ends of the first filter elements are in fluid communication with the inlet, while the second ends are in fluid communication with the outlet. The connector also includes a second housing that is in fluid communication with the hollow interior of the first housing. The second housing contains second filter elements that are arranged in a U-shape and are open at first and second ends thereof that are disposed proximate an outlet of the second housing. Fluid is conducted across the first filter elements to gain access to the second housing where the fluid is conducted across the second filter elements in order to exit to the second housing through the outlet.

In another embodiment, a fluid circuit that is fluidly connected to a plurality of external devices, such as dialysis machines, is provided. The fluid circuit is connected to a source of fluid, such as water, and each dialysis machine selectively receives fluid from the fluid circuit. The fluid circuit includes a plurality of connectors that are located along the fluid circuit. Each connector is operatively connected to one external device. Each connector includes a first housing having a hollow interior and an inlet and an outlet. The hollow interior includes first filter elements that are open at first and second ends thereof. The first ends of the first filter elements are in fluid communication with the inlet. The second ends are in fluid communication with the outlet. The connector also includes a second housing that is in fluid communication with the hollow interior of the first housing and is in selective fluid communication with the external device. The second housing contains second filter elements that are arranged in a U-shape and are open at first and second ends thereof that are disposed proximate an outlet of the second housing. Fluid is conducted across the first filter elements to gain access to the second housing where the fluid is conducted across the second filter elements in order to exit to the second housing through the outlet and flow to the external device.

### BRIEF DESCRIPTION OF THE DRAWINGS

FIG. 1 illustrates a conventional water treatment system including a water circuit;

FIG. 2 is a cross-sectional view of a conventional tee-connector used for connecting an external device, such as a dialysis machine, to the water circuit;

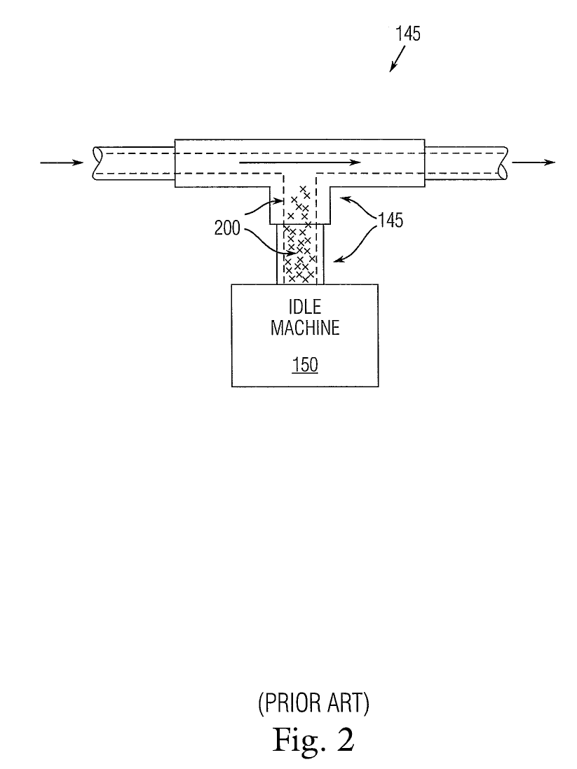

FIG. 3 is a side cross-sectional view of a hybrid tee-connector used in the water circuit in accordance with the present invention;

FIG. 4 is a local cross-sectional view of a hybrid tee-connector in accordance with another embodiment of the present invention;

FIG. 5 is a side cross-sectional view of a hybrid tee-connector in accordance with another embodiment of the present invention;

FIG. 6 is a cross-sectional view of a hybrid tee-connector in accordance with another embodiment of the present invention;

FIG. 7 is a local cross-sectional view of a side branch of the hybrid tee-connector; and

FIG. 8 is a cross-sectional view of a hybrid tee-connector in accordance with another embodiment of the present invention.

### DETAILED DESCRIPTION OF CERTAIN EMBODIMENTS OF THE INVENTION

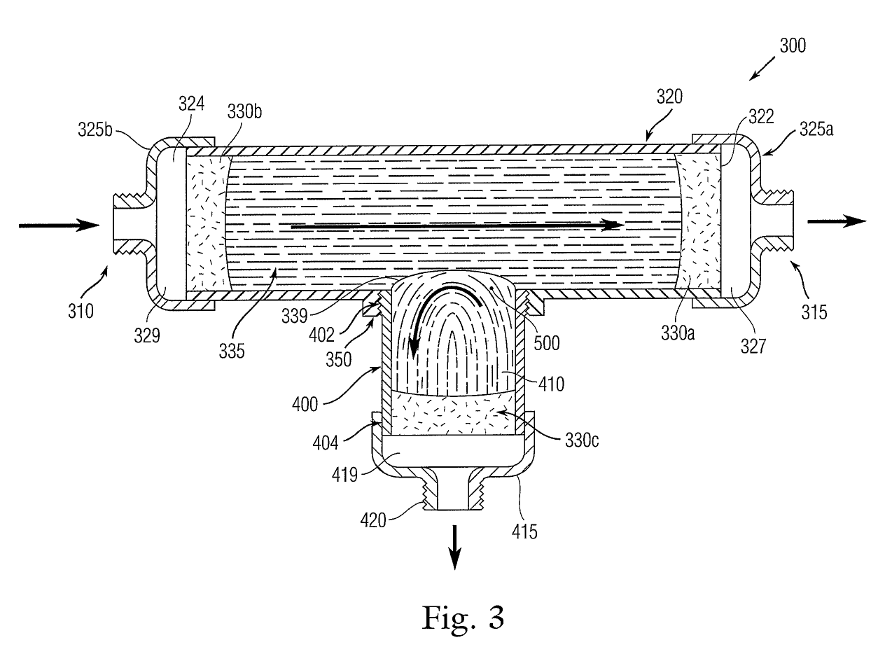

In accordance with one embodiment of the present invention, a hybrid tee-connector 300 is illustrated in FIG. 3 and is intended for incorporation into a fluid circuit (water) or the like for receiving fluid (water) from the circuit and delivering it to the external device. The hybrid tee-connector 300 is intended to be disposed along the circuit and, as described below, permits fluid to flow in the circuit and also permit fluid to flow selectively to the external device. For ease of simplicity the circuit is discussed in terms of being a water circuit and the fluid is water intended for use in a medical application or setting.

The hybrid tee-connector 300 can therefore connect a dialysis machine, such as machine 150a-150c, to the water circuit. However, it will be appreciated that the external device is not limited to being a dialysis machine but can be any type of machine that has a need for purified water in its operation.

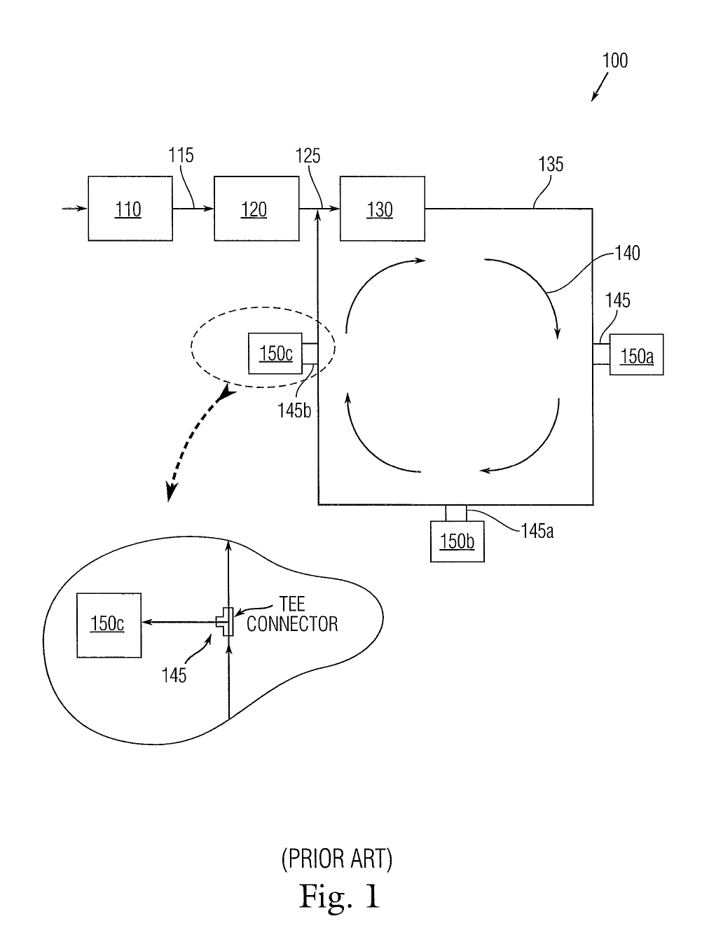

It will be appreciated that in the water filtration scheme and water circuit illustrated in FIG. 1, the hybrid tee-connector 300 of the present invention can replace the conventional tee-connector 145, thereby connecting any one of machines 150a-150c to the water circuit.

The hybrid tee-connector 300 has a first housing 320 that is defined by a first end 322 and a second end 324. The first housing 320 can have any number of different shapes including but not limited to circular, oval, square, etc. Typically, the first housing 320 has a circular shape.

The first housing 320 contains a plurality of semi-permeable membranes (first filter elements) 335 that serve as the filtering media of the connector 300. The semi-permeable membranes 335 can be in the form of a plurality of hollow fibers that are arranged in a bundle. The first housing 320 also includes a pair of potting compounds 330a-330b that are disposed at opposite ends 322, 324 of the first housing 320. The potting compound (e.g., polyurethane) provides an environmental barrier and encapsulates semi-permeable membranes 335 in the first housing 320. The potting compound forms a seal around the outside surfaces of the semi-permeable membranes. However, it will be appreciated that the potting compounds 330a, 330b do not seal the ends of the semi-permeable membranes 335 but instead, the ends of the semi-permeable membranes 335 are open at ends 322, 324 of the housing 320 to allow flow into and through the lumens of the hollow fibers.

The first housing includes a first header cap 325a that is coupled to the first end 322 of the housing 320 and a second header cap 325b that is coupled to the second end 324 of the housing 320. Typically, the first and second header caps 325a, 325b are removably (detachably) coupled to the housing 320. The first header cap 325a defines a first header space 327 that is formed between the first header cap 325a and the open ends of the semi-permeable membranes 335 and first potting compound 330a. Similarly, the second header cap 325b defines a second header space 329 that is formed between the second header cap 325b and the opposite open ends of the semi-permeable membranes 335 and second potting compound 330b.

The first header cap 325a includes a port 315 that provides communication with the first header space 327 and thus, provides fluid communication with the semi-permeable membranes 335. In the illustrated embodiment, the port 315 is in the form of an outlet or exit port since it permits fluid to exit the first header space 327. The outlet 315 can be a threaded port that permits a plug or the like to be threadingly mated thereto to close off the first header cap 325a as when the connector 300 is being stored or is not in use. Similarly, the second header cap 325b includes an inlet or port 310 that forms an entrance into the second header space 329 and thus, provides fluid communication with the semi-permeable membranes 335. The inlet 310 can be a threaded port that permits a plug or the like to be threadingly mated thereto to close off the second header cap 325b as when the connector 300 is being stored or is not in use.

The hybrid tee-connector 300 can be connected to the main conduit section 135 of the circuit by the inlet 310 and the outlet 315. In other words, the connector 300 replaces the conventional connector 145 shown in FIG. 1 and an upstream section of the main conduit section 135 is fluidly connected to the inlet 310, while a downstream section of the main conduit section 135 is fluidly connected to the outlet 315.

The fibers serve as a means for filtering the water that flows within the water distribution (RO) loop 140 since the flowing water flows through the inlet 310, through the second header space 329 and into the semi-permeable membranes 335. The semi-permeable membranes 335 can be of any type suitable for this type of application and are commercially available from a number of sources.

While some of the water introduced into the connector 300 flows through the semi-permeable membranes 335 and exits into the first header space 327 before exiting through the outlet 315, water also is conducted across the walls of the semi-permeable membranes, thereby causing filtration of the water.

In accordance with the present invention, the connector 300 is designed to overcome the deficiencies associated with conventional tee-connectors that are used in water circuits and in particular, the connector 300 is designed to eliminate the chance that stagnant water (bacteria laden) that is trapped within the connector from being delivered to the external device (e.g., a dialysis machine). The connector 300 is constructed to include a side branch or second housing 400 as illustrated in FIG. 3 that is in fluid communication with an interior of the first housing 320. In particular, the first housing 320 includes an opening 339 that fluidly links the first housing 320 with the second housing 400.

The second housing 400 is preferably removably coupled to the first housing 320 using conventional techniques including using a threaded attachment therebetween or the use of other mechanical attachment means. In FIG. 3, the first housing 320 includes a flange or boss 350 that extends outwardly from the exterior of the first housing 320 and surrounds the opening 339. The flange 350 can be integrally formed with the first housing 320. The second housing 400 is coupled to the flange 350.

The second housing 400 has a first end 402 and an opposing second end 404 both of which are open. The first end 402 is coupled to the first housing 320 (e.g., to the flange 350). Similar to the first housing 320, the second housing 400 includes semi-permeable membranes (second filter elements) 410 that serves to filter fluid, such as water. The semi-permeable membranes 410 can be bundles of fibers as in the fibers 335 of the first housing 320. Unlike the linear, longitudinal orientation of the fibers 335 in the first housing 320, the fibers 410 are bent so that they assume a U-shape with the opposing open ends of the fibers 410 being disposed at the same end of the second housing 400.

The second housing 400 includes a potting compound 330c that is disposed at the second end 404. The two open ends of the U-shaped fibers 410 are contained within the potting compound 330c in such away that the potting compound 330c holds and retains the fibers 410 but does not seal them. In other words, the fibers 410 are open along the second end 404 of the housing 400.

A side branch header cap 415 is coupled to the second end 404 of the housing 400 and defines a side branch header space 419 that is defined between the ends of the fibers 410/potting compound 330c and the cap 415. The side branch cap 415 includes an outlet or port 420. The port 420 can contain threads or other coupling features to permit a plug or the like to be coupled thereto as for closing off the port 420 when the connector 300 is being stored or is not in use.

As shown in FIG. 3, there is a space 500 that is formed above the U-shaped fibers 410. More specifically, the space 500 is formed between the closed end of the U-shaped fibers 410 and the first end 402 of the housing 400. The space 500 is therefore adjacent the opening 339 and receives the fluid as it passes from the interior of the housing 320 to the interior of the second housing 400.

The side branch header cap 415 can include an automatic shutoff valve 420 that serves to controllably limit the flow of the water through the second housing 400 to the external device (e.g., dialysis machine 150a-150c). The flow of water through the second housing 400 is now described.

It will first be appreciated that the water that flows to the second housing 400 is water that has been conducted across the walls of the semi-permeable membranes 335 since the opening 339 only communicates with the space surrounding the semi-permeable membranes 335. Thus, water that has been once filtered by means of conduction across the semi-permeable membranes 335 passes through the opening and into the second housing 400. The water flows first into the space 500 and since only the open lumens of the semi-permeable membranes 410 are in fluid communication with the side branch header space 419, water must flow across (convection) the walls of the semi-permeable membranes 410 and into the lumens thereof in order to flow into the side branch header space 419 and thereby exit the second housing 400 through the outlet 420. As mentioned above, the operation of the valve 420 controls the flow of water from the second housing 400.

The semi-permeable membranes 410 thus provide a redundant filtration scheme where the water is filtered and purified a second time by being conducted across the walls of the semi-permeable membranes 410 before exiting the side branch of the connector 300.

It will be appreciated that the connector 300 of the present invention overcomes the deficiencies of the prior art tee-connectors since water that passes into the side branch connector portion (the second housing 400) has already been once filtered by being conducted across the walls of the semi-permeable membranes 335 in the first housing 320. As a result, any water that occupies the space 500 has been previously filtered and purified and therefore, even in the event that the water remains stagnant in the space 500, the water is purified and therefore, is free of bacteria. In other words, unlike conventional tee-connectors, the presence of stagnant water in the side branch of the second housing 400 will not result in the formation of bacteria, bio-films, etc. In any event, the redundant filtration scheme of the second housing 400 ensures that the water that is delivered to the external device is filtered, purified water.

In a particular embodiment of the invention, the second housing can be replaced or detached from the first housing. In accordance with another embodiment of the present invention, the second housing can be a single unit incorporated within the first housing.

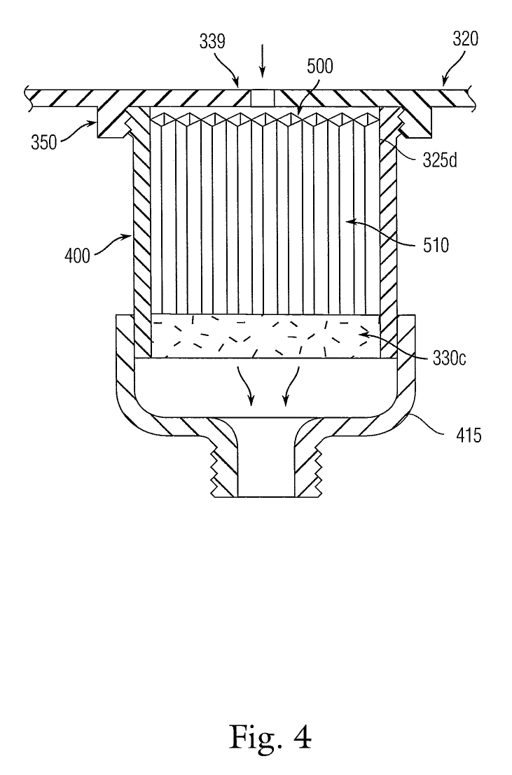

In another embodiment of the invention, as illustrated in FIG. 4, the filtering media of the second housing 400 include a second type of filter media in the form of a flat sheet (folded) membrane 510.

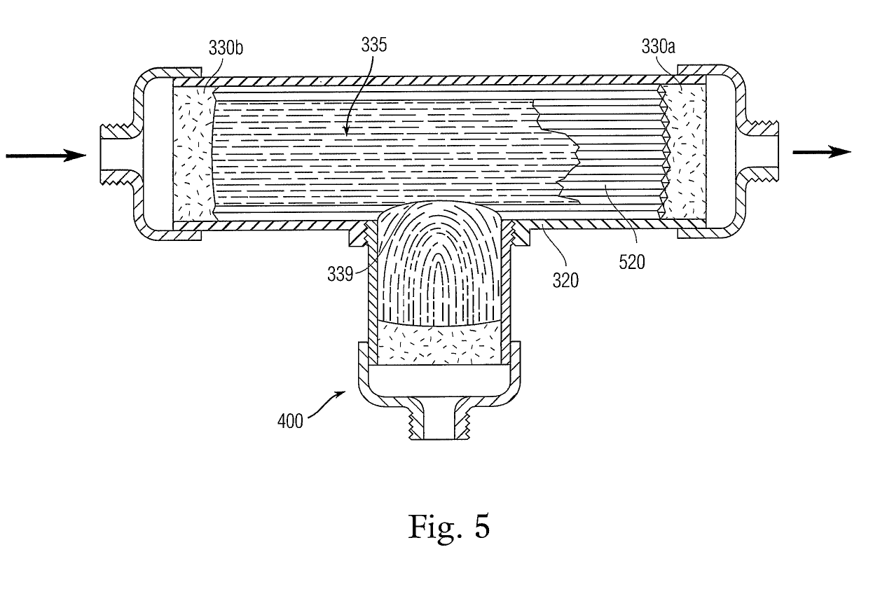

As shown in FIG. 5, the main first housing 320 can also include an additional filter media and in particular, a flat sheet (folded) membrane 520 can be disposed around the semi-permeable membranes 335 and encased in the potting compounds 330a & 330b. The membrane 520 thus surrounds the semi-permeable membranes 335. The membrane 520 can be a part of the main first housing 320. In any event, the membrane 520 can be positioned within the housing 320 such that a space is formed between the outer surface of the membrane 520 and the inner wall of the housing 320 to permit water that has been conducted across the semi-permeable membranes 335 and through the membrane 520 to flow within the space to the opening 339 to reach the second housing 400. Alternatively, the membrane 520 can be in close proximity with the inner surface of the main first housing 320.

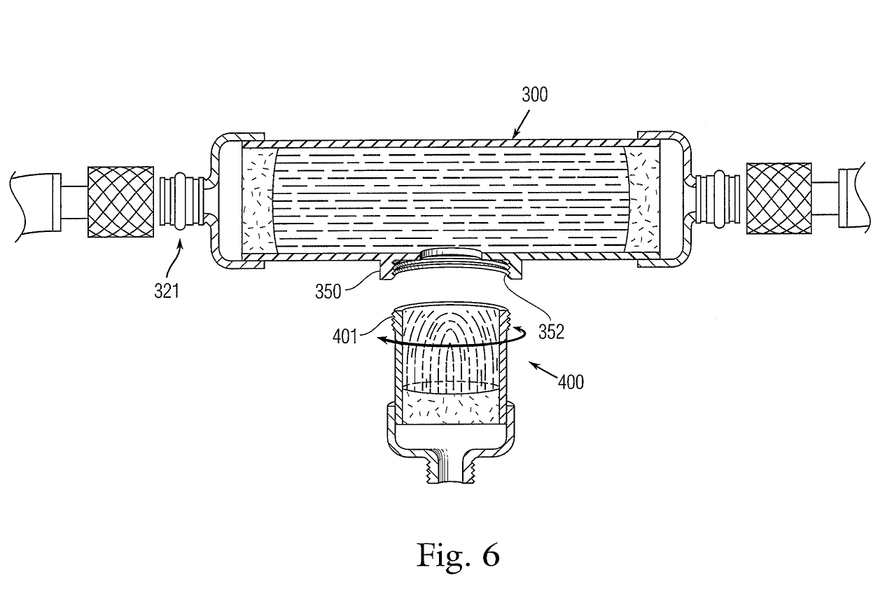

FIG. 6 shows a different embodiment of the present invention in which the second housing 400 is removable/replaceable. For example, the flange 350 that extends outwardly from the housing 320 can include threads 352 along its inner surface and the second end of the second housing 400 includes complementary threads 401. To securely and sealingly couple the second housing 400 to the main first housing 320, the threads of the second housing 400 and the flange 350 are mated together to threadingly couple the two housings together.

The inlet and outlet of the main first housing 320 can each include a stem or neck 321 that includes a quick connector to permit quick and easy coupling between the connector 300 and the free ends of the water circuit.

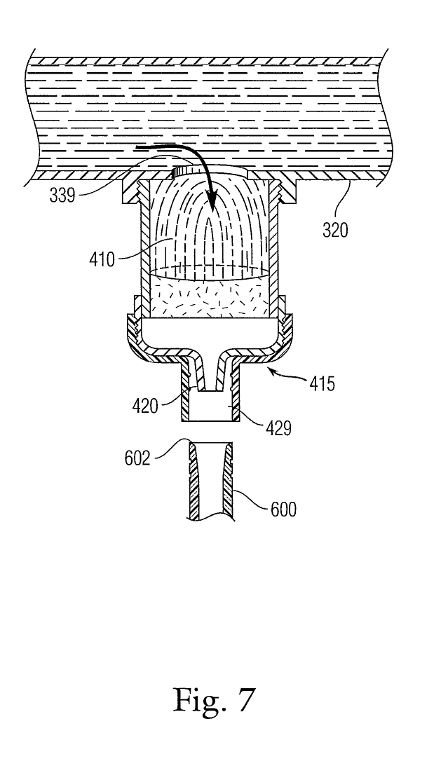

FIG. 7 shows another feature that can be incorporated into the connector 300 of the present invention. More particularly, the side branch header cap 415 can be formed to include a recessed fitting to mitigate contamination of the outlet port 420. In particular, a sleeve or protective structure 429 can be formed about the outlet port 420. A free end 602 of a conduit 600 is designed to mate with the outlet port 420 for fluidly connecting the external device (dialysis machine) to the second housing 400.

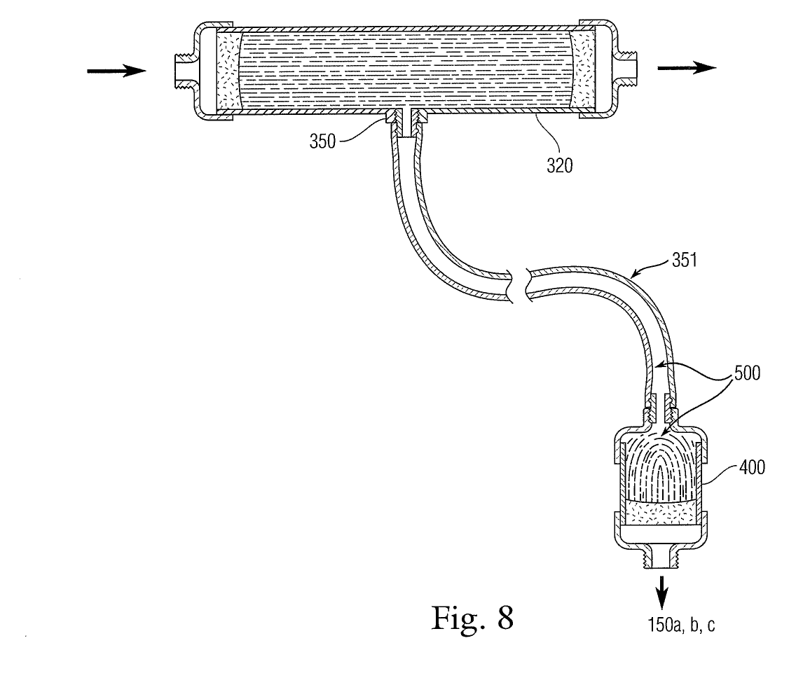

FIG. 8 shows another feature that can be incorporated into connector 300 whereby a flexible 351 connects main housing 320 to second housing 400. This having the advantage of placing the second redundant filter element closer to the external machine 150a, 150b, 150c, and thus minimizing contamination downstream of connector 300 prior to enter machine.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A connector for use in a fluid circuit comprising:
a first housing having a hollow interior and an inlet and an outlet, wherein the hollow interior includes first filter elements that are open at first and second ends thereof, the first ends of the first filter elements being in fluid communication with the inlet, the second ends being in fluid communication with the outlet; and
a second housing that is in fluid communication with the hollow interior of the first housing, the second housing containing second filter elements that are arranged in a U-shape and are open at first and second ends thereof that are disposed proximate an outlet of the second housing, wherein fluid is conducted across the first filter elements to gain access to the second housing where the fluid is conducted across the second filter elements in order to exit to the second housing through the outlet.

2. The connector of claim 1, wherein the connector is a tee-connector.

3. The connector of claim 1, wherein the first and second filter elements comprise semi-permeable membranes.

4. The connector of claim 3, wherein the semi-permeable membranes comprise hollow fibers.

5. The connector of claim 1, wherein the second housing comprises a branch of the connector that is coupled to and extends outwardly from a side of the first housing with an opening being formed in the first housing to permit fluid to flow therethrough into the second housing.

6. The connector of claim 1, wherein a closed end of the U-shaped second filter elements is disposed proximate an end of the second housing that is coupled to the first housing.

7. The connector of claim 6, wherein a space is formed between the closed end of the U-shaped second filter elements and an opening formed in the first housing that provides fluid communication to the second housing, the space being sealed from the outlet of the second housing by a potting compound that surrounds the first and second ends of the U-shaped second filter elements.

8. The connector of claim 1, wherein the second housing is removably coupled to the first housing.

9. A fluid circuit that is fluidly connected to a plurality of external devices that selectively receive fluid from the fluid circuit, the fluid circuit comprising:
a plurality of connectors that are located along the fluid circuit, each connector being operatively connected to one external device, each connector including:
a first housing having a hollow interior and an inlet and an outlet, wherein the hollow interior includes first filter elements that are open at first and second ends thereof, the first ends of the first filter elements being in fluid communication with the inlet, the second ends being in fluid communication with the outlet; and
a second housing that is in fluid communication with the hollow interior of the first housing and is in selective fluid communication with the external device, the second housing containing second filter elements that are arranged in a U-shape and are open at first and second ends thereof that are disposed proximate an outlet of the second housing, wherein fluid is conducted across the first filter elements to gain access to the second housing where the fluid is conducted across the second filter elements in order to exit to the second housing through the outlet and flow to the external device.

10. The fluid circuit of claim 9, wherein the external devices comprise a plurality of dialysis machines and the fluid is water.

11. The fluid circuit of claim 9, further including a folded sheet membrane that is disposed about at least one of the first and second filter elements.

12. The fluid circuit of claim 9, wherein one upstream section of a fluid distribution loop that carries a circulating fluid is connected to the inlet of the first housing and one downstream section of the loop is connected to the outlet of the first housing and the fluid is circulated within the loop through the first filter elements in the first housing.

13. The fluid circuit of claim 9, wherein the second housing represents a side branch of the connector that permits fluid introduced through the inlet of the first housing to flow into the side branch to the external device connected thereto.

14. The fluid circuit of claim 9, wherein the first filter elements comprise hollow longitudinal semi-permeable fibers that are secured at the first end of the first housing with a first potting compound and at the second end of the first housing with a second potting compound.

15. The fluid circuit of claim 14, further including a first header cap attached to the first end of the first housing to define a first header space and a second header cap attached to the second end of the first housing to define a second header space, the first header cap including the inlet that forms an entrance into the first header space, the second header cap including the outlet that forms an exit from the second header space.

16. The connector of claim 1, wherein the second housing is coupled to the first housing via a flexible conduit.

17. A connector for use in a fluid circuit comprising:
a first housing having a hollow interior and an inlet and an outlet, wherein the hollow interior includes first filter elements that are open at first and second ends thereof, the first ends of the first filter elements being in fluid communication with the inlet, the second ends being in fluid communication with the outlet; the first housing being configured for receiving fluid within hollow lumens of the first filter elements at the inlet and permitting the fluid to exit through the hollow lumens at the outlet, and
a second housing that is in fluid communication with the hollow interior of the first housing at a location exterior to the first filter elements, the second housing containing second filter elements that are arranged in a U-shape and are open at first and second ends thereof that are disposed proximate an outlet of the second housing, wherein fluid is conducted from an interior of the hollow lumens across the first filter elements to gain access to the second housing in which the fluid is conducted across the second filter elements in order to exit to the second housing through the outlet.
